(19) United States
(12) Patent Application Publication
(10) Pub. No.: US 2026/0003891 A1
(43) Pub. Date: Jan. 1, 2026

(54) ARTIFICIAL INTELLIGENCE-BASED LOG AUGMENTATION AND CLUSTERING

(71) Applicant: Palo Alto Networks, Inc., Santa Clara, CA (US)

(72) Inventors: Puneet Gupta, Bengaluru (IN); Peter Kirubakaran Navamani, Bangalore (IN); Ramesh Nampelly, Livermore, CA (US); Pradeepkumar Vijaya Kumar, Dublin, CA (US)

(21) Appl. No.: 18/758,908

(22) Filed: Jun. 28, 2024

(51) Int. Cl. G06F 16/28

(52) U.S. Cl. CPC G06F 16/285

(57) ABSTRACT

A log system prompts a foundation model to identify regular expressions that delineate single line logs in log files and incorporates user feedback for the regular expressions in a feedback loop as part of a hybrid parsing approach. The log system splits the log files into single line logs according to the regular expressions and augments the single line logs with classifications and values of metadata fields. The augmented single line logs are then clustered into hierarchical clusters with corresponding cluster patterns and the log system stores the augmented single line logs in a database indexed by the classifications and values of metadata fields and associated with corresponding clusters/cluster patterns. A presentation module accesses the database when responding to user queries for filtered single line logs and log correlations/root cause analysis.

### BACKGROUND

The disclosure generally relates to data processing (e.g., CPC subclass G06F) and to computing arrangements based on specific computational models (e.g., CPC subclass G06N).

Regular expressions (regex) are used for parsing log files, enabling the extraction and analysis of specific pieces of information from large and complex text data. Each line in a log file typically follows a predefined format, including timestamps, error codes, user identifiers, uniform resource locators, or other pertinent details. Regular expressions use patterns to match and capture these elements, facilitating the identification and extraction of relevant data. For instance, a regex pattern can be designed to locate all timestamps in a log file, which can then be used for chronological sorting or identifying specific time-based events. Similarly, regex can isolate error messages by matching patterns associated with error codes or specific keywords. This targeted data extraction simplifies subsequent analysis, such as identifying frequent errors, tracking user activity, or monitoring system performance.

Rapid developments in artificial intelligence (AI) technologies have spawned numerous terms with fluid meanings. Recently, AI technologies are frequently referred to with the terms large language model (LLM), generative AI, and foundation model. Many of these technologies are based on or relate to the “Transformer” architecture.

A “Transformer” was introduced in VASWANI, et al. “Attention is all you need” presented in Proceedings of the 31st International Conference on Neural Information Processing Systems on December 2017, pages 6000-6010. The Transformer is a first sequence transduction model that relies on attention and eschews recurrent and convolutional layers. The Transformer architecture has been referred to as a “foundational model.” The Center for Research on Foundation Models at the Stanford Institute for Human-Centered Artificial Intelligence used this term in an article “On the Opportunities and Risks of Foundation Models” to describe a model trained on broad data at scale that is adaptable to a wide range of downstream tasks. There has been subsequent research in similar Transformer-based sequence modeling. The architecture of a Transformer model typically is a neural network with transformer blocks/layers, which include self-attention layers, feed-forward layers, and normalization layers. The Transformer model learns context and meaning by tracking relationships in sequential data.

Some LLMs are based on the Transformer architecture. An LLM is “large” because the training parameters are typically in the billions and have been approaching a trillion parameters. AI technologies are not limited to LLMs and research and utilization of “lightweight” language models (i.e., fewer parameters than large) has grown. Language models can be pre-trained to perform general-purpose tasks or tailored to perform specific tasks. Tailoring of language models can be achieved through various techniques, such as prompt engineering and fine-tuning.

### BRIEF DESCRIPTION OF THE DRAWINGS

Embodiments of the disclosure may be better understood by referencing the accompanying drawings.

FIG. 1 is a schematic diagram of an example system for augmenting and clustering single line logs to facilitate analytics and presentation of analytics to users.

FIG. 2 is a diagram illustrating an example single line log, augmented metadata for the single line log, and hierarchical clusters that include the single line log.

FIG. 3 is an illustrative diagram of example user interfaces (UIs) that display log data indexed by metadata and/or correlated across time periods.

FIG. 4 is a flowchart of example operations for maintaining a database of single line logs indexed by augmented metadata and grouped by cluster patterns.

FIG. 5 is a flowchart of example operations for responding to a natural language user query related to single line logs to resolve the natural language user query.

FIG. 6 is a flowchart of example operations for generating a response to a user query indicating filters and/or correlations of single line logs to resolve the user query.

FIG. 7 is a flowchart of example operations for performing root cause analysis of failures with augmented single line logs.

FIG. 8 depicts an example computer system with a log augmenting/indexing system, a hierarchical clustering model, and a log analytics/presentation module.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Pipelines that process and generate interpretable insights from log files suffer from an overabundance of log data. Often, billions of log files can be generated daily, and each log file is often presented in an unstructured format. This results in rigid, regular expression (“regex”)-based pattern detection methods for indexing that do not provide intuitive, user-friendly ways to sort log files. This approach is additionally rigid because the regular expressions are typically handcrafted prior to parsing log files which restricts the malleability and breadth of pattern detection as log files vary in structure across contexts. The present disclosure proposes an AI pipeline for indexing, augmenting, and clustering log files to facilitate improved log analytics for high volumes of log files.

A log indexing/augmenting system (“log system”) receives multi-line logs comprising unstructured data logged from various data sources (e.g., software testing modules, firewalls, etc.). The log system applies a hybrid parsing approach to convert the multi-line logs into single line logs. A machine learning model is applied to identify regular expressions that delineate single line logs within the multi-line logs. Additionally, the regular expressions are presented to an administrator or user of an organization or other entity managing the logs. The administrator filters out regular expressions that are incorrect or have no meaningful interpretation and, optionally, adds additional regular expressions known to delineate single line log lines for a context where the single line logs originated and/or type of logging software. Once grouped into single line logs according to the regular expressions, the log system augments the single line logs with metadata before storing the augmented single line logs in a database indexed by metadata. Examples of the metadata include corresponding regular expressions, service name, issue type, application type, severity level, timestamp, etc. To facilitate log analytics to present to a user, the single line logs are clustered with a hierarchical clustering algorithm (e.g., LogMine) that generates hierarchical groupings of single line logs labelled with corresponding patterns at each level of the hierarchy.

Once the log files are preprocessed into single lines, indexed by regular expressions, and grouped by cluster patterns, a log analytics/presentation module (“presentation module”) comprising a chatbot interacts with the user. When the user submits a query to the presentation module, the presentation module generates a prompt for a large language model (LLM) that indicates patterns used in the hierarchical grouping of clusters and that instructs the LLM to retrieve data from the database of augmented single line logs to respond to the user query. The presentation module also presents a user interface that allows for various log analytics such as log summarization, event correlation, comparisons across time intervals, inter- and intra-cluster correlation using metadata, and log filtering. The intelligent log parsing/augmentation preprocessing performed by the log system facilitates high quality log analytics for high volumes of log files and an interactive chatbot that can directly access and process clustered single line logs to respond to user queries.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

A “single line log” refers to a section of a log file corresponding to a timestamp indicated in the log file. Log files may contain multiple single line logs without delineation between each single line log, and a single timestamp may correspond to multiple single line logs when that timestamp is indicated in multiple sections of a logfile (e.g., when multiple errors occur at a timestamp).

### Example Illustrations

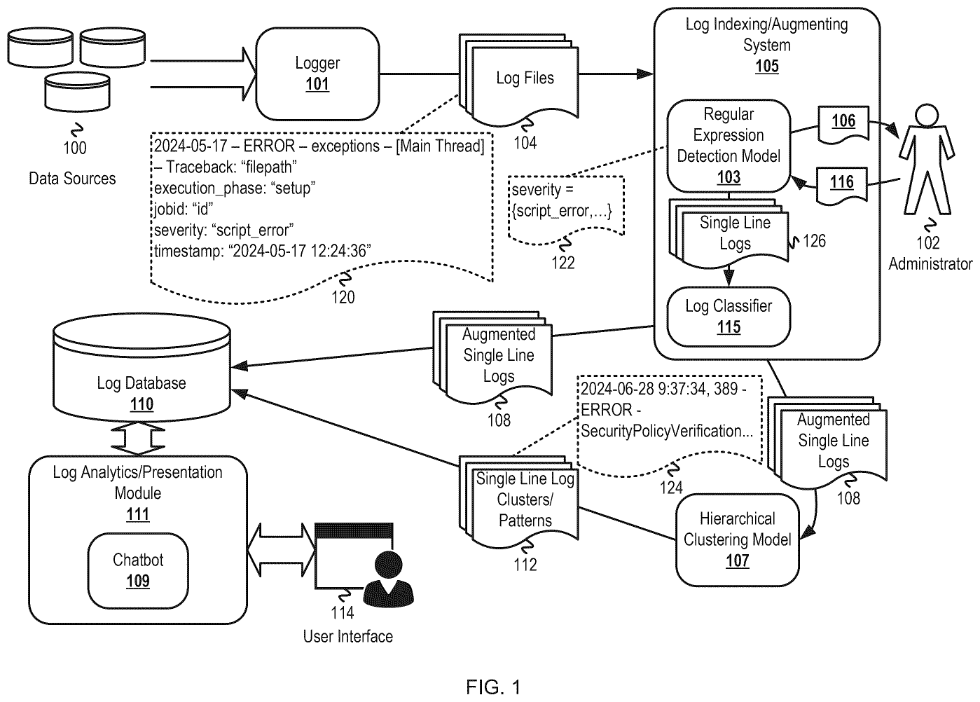

FIG. 1 is a schematic diagram of an example system for augmenting and clustering single line logs to facilitate analytics and presentation of analytics to users. The example system in FIG. 1 comprises a logger 101 that generates (possibly unstructured) log files from data sources 100, a log indexing/augmenting system (“log system”) 105 that structures/augments the log files, a hierarchical clustering model 107 that generates pattern-based clusters of logs, and a log analytics/presentation module (“presentation module”) 111 that interacts with a user interface 114 for presentation of log analytics and responding to user queries.

The logger 101 monitors events occurring at data sources 100 and generates log files 104 for monitored events. For instance, the log files 104 can be for system log files of system events, security log files of events related to security, web server log files of requests at web servers, error log files for error events, testing log files, etc. Accordingly, the log files 104 can have varying formats and, in many instances, may not have structure that indicates types of single line logs, markers for beginnings and endings of each single line log, etc. Example single line log 120 comprises the following text:

2024-05-17 - ERROR - exceptions -
[Main Thread] - Traceback: “filepath”
execution_phase: “setup”
jobid: “id”
severity: “script_error”
timestamp: “2024-05-17 12:24:36”
Additional log fields can comprise test case
identifiers, test suite identifiers, etc.

The log system 105 receives the log files 104 and applies parsing and classification operations to generate augmented single line logs 108. Before parsing/classification, the log system 105 scans the log files 104 and removes personally identifiable information (PII). For instance, the log system 105 can use a third-party data loss prevention tool to detect and remove PII. The log system 105 includes a regex detection model 103 and a log classifier 115. Generating the augmented single line logs 108 involves processing by these components 103, 115 along with inputs from an administrator 102.

The regular expression detection model 103 receives the log files 104 (with PII removed) in batches and generates regular expressions that split multi-line logs in the log files 104 into single line logs 126. For instance, the regular expression detection model 103 can comprise a Google® Vertex artificial intelligence (“AI”) LLM or Google Gemini AI LLM prompted with a prompt generated from the following template:

I have a batch of log lines from a file: {{current log file batches}}
I want to split these lines into single, meaningful log lines using regex patterns. I've
previously used these patterns for similar log files: {{previous log file regex}}
Give me one or more regex patterns to split these complete log files into single log lines.
A log line in this particular log starts from a timestamp and ends before another
timestamp, anything in between is considered as a single log line. Make sure to properly
define the proper starting and ending.
Note: give me only regex, no explanation needed, return all generated regex in a list.
**example output** : {sample regex output}

Once the regular expression detection model 103 generates regular expressions 106 for a batch (e.g., 32000 tokens) of log files, the regular expression detection model 103 validates the regular expressions 106 against log files with known delineations of single line logs to determine a success rate of the regular expressions 106. If the success rate is below a threshold (e.g., 70%), the regular expression detection model 103 can update the regular expressions 106, for instance by prompting an LLM with an additional prompt that comprises instructions to update the regular expressions 106 and can indicate failures for detections by the regular expressions 106.

When the regular expressions 106 are validated, the regular expression detection model 103 communicates the regular expressions 106 to an administrator 102. The administrator 102 evaluates the regular expressions 106 and has the option to remove regular expressions that are incorrect or not interpretable and add regular expressions known to be functional (e.g., according to domain-level knowledge). The administrator 102 then communicates updated regular expressions 116 to the regular expression detection model 103. This process iteratively refines the generated regular expressions across batches until, after a final batch, the log files 104 are processed to generate the single line logs 126 according to the final regular expressions. Example regular expression 122 indicates a pattern comprising list of values matching a severity field including “script_error” (this example is illustrative and not expressed as an actual regular expression).

The log classifier 115 receives the single line logs 126 and generates augmented single line logs 108. The augmented single line logs 108 include classifications of single line logs such as error types (e.g., database, network, application), execution phases (e.g., setup, cleanup, execution), application programming interface (API) types (e.g., delete, create, post, get), etc. that can be used to further index single line logs. The log classifier 115 can additionally augment the single line logs 126 with values of metadata fields such as timestamps, log severity, etc. The log classifier 115 can comprise a machine learning classifier such as a zero-shot classification model (e.g., the Meta® Bidirectional and Auto-Regressive Transformers Large Natural Language Inference model), a machine learning classifier trained on augmented single line logs with corresponding labels such as a support vector machine, a regression model, a random forest classifier, etc. Depending on implementations, for instance when there is a significant volume of single line logs, classification can be performed on a representative single line log for subsets of the single line logs, for instance single line logs with certain index values, representative single line logs within clusters generated by the hierarchical clustering model 107, representative single line logs within each log file, etc. The log classifier 115 adds classifications of single line logs as metadata and communicates the augmented single line logs 108 to a log database 110 for storage and indexing.

The hierarchical clustering model 107 also receives the augmented single line logs 108 and generates single line log clusters/patterns 112. Each pattern in the single line log clusters/patterns 112 comprises a pattern that matches each single line log within a corresponding cluster, and the patterns function as informative labels for the clusters. For instance, the hierarchical clustering model 107 can use the LogMine clustering algorithm to generate the single line log clusters/patterns 112. The LogMine clustering algorithm performs iterative clustering at each hierarchical level and, at clusters obtained from each iteration of clustering/hierarchical level, the algorithm performs pattern recognition to identify a pattern for logs contained in each of the clusters. At a first iteration, the hierarchical clusters comprise each of the augmented single line logs and the patterns comprise the single line logs themselves. At subsequent iterations, the algorithm performs clustering with relaxed conditions such that fewer clusters are obtained. The algorithm then identifies patterns for each of the clusters using pattern recognition such that for each identified pattern, every single line log in the corresponding cluster satisfies that pattern. This iterative process continues until a final iteration having a single cluster, wherein the pattern comprises a pattern that matches every single line log (e.g., wildcard patterns for each field in a single line log).

The single line log clusters/patterns 112 can be obtained from clustering and applying pattern recognition within clusters of single line logs using any clustering algorithm including clustering algorithms without hierarchy. Additionally, any pattern recognition algorithms for assigning pattern labels to clusters such that single line logs within each cluster satisfy patterns indicated at each label can be implemented. The LogMine clustering algorithm is presented due to its efficiency in the context of log files.

Additionally, the augmented single line logs 108 can be filtered prior to clustering. For instance, the augmented single line logs 108 can be filtered by metadata fields and/or classifications (e.g., only error single line logs). Filtering of the augmented single line logs 108 prior to clustering reduces the dataset size for clustering, thereby improving performance. Moreover, the resulting clusters are more targeted towards the filtered logs which allows for more granular analysis. To exemplify, when the augmented single line logs 108 are filtered to only be error logs, this facilitates root cause analysis for errors using the resulting clusters. Multiple filters can be applied, and clustering can occur for each of the applied filters depending on desired clusters for log analysis.

Example cluster pattern 124 comprises an error warning 389 at timestamp 2024-06-28 9:37:34 under security policy verification. Full text for the example cluster pattern 124 can comprise “2024-06-28 9:37:34, 389-ERROR-SecurityPolicyVerification-[Mainthread]-Failed to verify flow on flow browser”. In this example, the corresponding cluster can comprise all single line logs associated with the error warning described by this metadata. Alternatively, a cluster pattern can comprise all single line logs that are errors in the main thread for security policy verification, and the corresponding cluster would include single line logs with other time stamps, other error codes, and other descriptions. The example cluster pattern 124 was identified at a pattern recognition phase of the LogMine clustering algorithm for the cluster. The single line log clusters/patterns 112 augment analytics for root cause analysis of problems. For instance, an issue related to a single line log can be traced through other single line logs with the same cluster for root cause analysis.

The presentation module 111 interfaces with the log database 110 and the user interface 114. The user interface 114 presents a portal that includes fields for filtering single line logs by indexes in the log database 110 (e.g., time intervals, issue types, API call types, etc.), correlating events by performing lookups of single line logs with same indexes and/or within same clusters, correlating events across separate time intervals, etc. The user interface 114 can provide an interface for further functionality such as error detection, anomaly detection, vulnerability detection, and a service graph where service was impacted due to an analyzed issue.

The presentation module 111 also comprises a chatbot 109. The chatbot 109 is prompted with a prompt that indicates natural language processing (NLP) embeddings of patterns in the single line log clusters/patterns 112 to facilitate responding to user queries received via the user interface 114. The prompt additionally indicates text of the user queries and instructions to respond to the user queries by accessing the log database 110 while leveraging indices of the log database 110 constructed using classifications and values of metadata fields from augmentations of the augmented single line logs 108 and the pattern embeddings. For instance, the chatbot 109 can comprise an LLM (e.g., the GPT-4® LLM) that is able to generate NLP embeddings of each user query and determine if any of the embeddings are close to the pattern embeddings. Based on matches or proximity to the pattern embeddings, the LLM can then look for single line logs within a corresponding cluster to respond to the user query. The LLM can additionally have knowledge of remediation resources provided by the user interface 114 to include in a response.

An example prompt to the chatbot 109 to analyze a set of augmented single line logs to extract relevant timeline-related information from the augmented single line logs comprises the following: You are a highly skilled log analyzer and timeline creator. Given a set of log entries, each containing a unique timestamp and a description of an event, your task is to generate a concise and chronological timeline summarizing the key events.

### <<Log Entries>>

An example prompt to the chatbot 109 for retrieving augmented single line logs, patterns, etc. relevant to a user query comprises the following:
1. Fetch log entries within Time. If Time is not provided, consider the last 30 minutes or 1 hour depending on log pattern volume.
2. If possible, fetch filters and use filters to reduce the log corpus.
3. Use vectorization on the reduced log corpus to identify the top-20 nearest log patterns to each user query.

An example prompt to the chatbot 109 for responding to the user query after the retrieval of augmented single line logs, patterns, etc. comprises the following: You are a log analysis expert. I will provide you with a set of log entries, each containing a unique pattern and a timestamp. Analyze the log entries and understand the underlying events they describe.

After analyzing the logs, answer user queries about the events recorded in the log entries. You should use your understanding of the log data to provide accurate and concise answers.

### EXAMPLE

Timestamp: 2024-06-25 12:54:54
Pattern: User_A logged in
<<User Queries>>
Your response should be clear, concise, and based on the information provided in the log
entries.
Example user query: Were there any error messages in the last hour for database failure
in Kafka?

Although the above prompts refer to “log entries”, they can alternatively refer to “single line logs” and/or “augmented single line logs”.

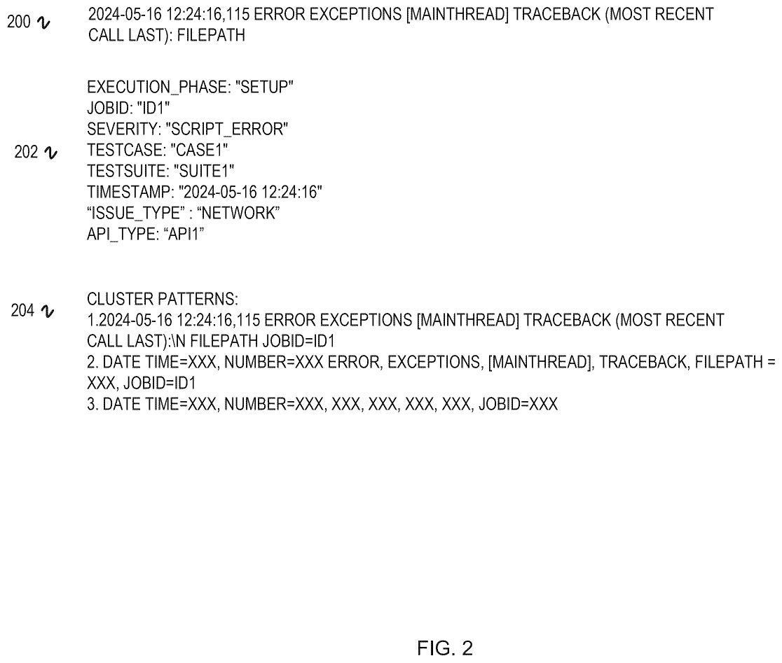

FIG. 2 is a diagram illustrating an example single line log, augmented metadata for the single line log, and hierarchical clusters that include the single line log. Example single line log 200 comprises the following text: 2024-05-16 12:24:16, 115 ERROR EXCEPTIONS [MAINTHREAD] TRACEBACK (MOST RECENT CALL LAST):\N FILEPATH1

Example augmented metadata 202 for the example single line log 200 comprises the following text:
EXECUTION_PHASE: “SETUP”
JOBID: “ID1”
SEVERITY: “SCRIPT_ERROR”
TESTCASE: “CASE1”
TESTSUITE: “SUITEl”
TIMESTAMP: “2024-05-16 12:24:16”
“ISSUE_TYPE”: “NETWORK”
API_TYPE: “API1”

Example hierarchical cluster patterns 204 (i.e., pattern comprising informative labels for clusters in a hierarchical structure) for the example single line log 200 comprise the following:
CLUSTER PATTERNS:
1. 2024-05-16 12:24:16, 115 ERROR EXCEPTIONS [MAINTHREAD] TRACEBACK (MOST RECENT CALL LAST): FILEPATH1 JOBID=ID1
2. DATE TIME=XXX, NUMBER=XXX ERROR, EXCEPTIONS, [MAINTHREAD], TRACEBACK, FILEPATH=XXX, JOBID=ID1
3. DATE TIME=XXX, NUMBER=XXX, XXX, XXX, XXX, FILEPATH=XXX, JOBID=XXX

The hierarchical cluster patterns 204 start at a lowest level in the hierarchy (i.e., the single line log 200) and sequentially ascend levels in the hierarchy. For instance, the second pattern “2.” comprises single line logs at any time, with any error number, that are exceptions in the main thread with a traceback to any file path and have job identifier “ID1”. This second pattern for detecting this cluster includes the text “EXCEPTIONS”, “[MAINTHREAD]”, “TRACEBACK”, and “JOB=ID1”. The third cluster pattern “3.” comprises every single line log (i.e., the aggregate of every cluster). Additional patterns between the first pattern “1.” and second pattern “2.” could impose that the error number is 115, that the date time is 2024-05-16 between 12:00:00 and 1:00:00, etc.

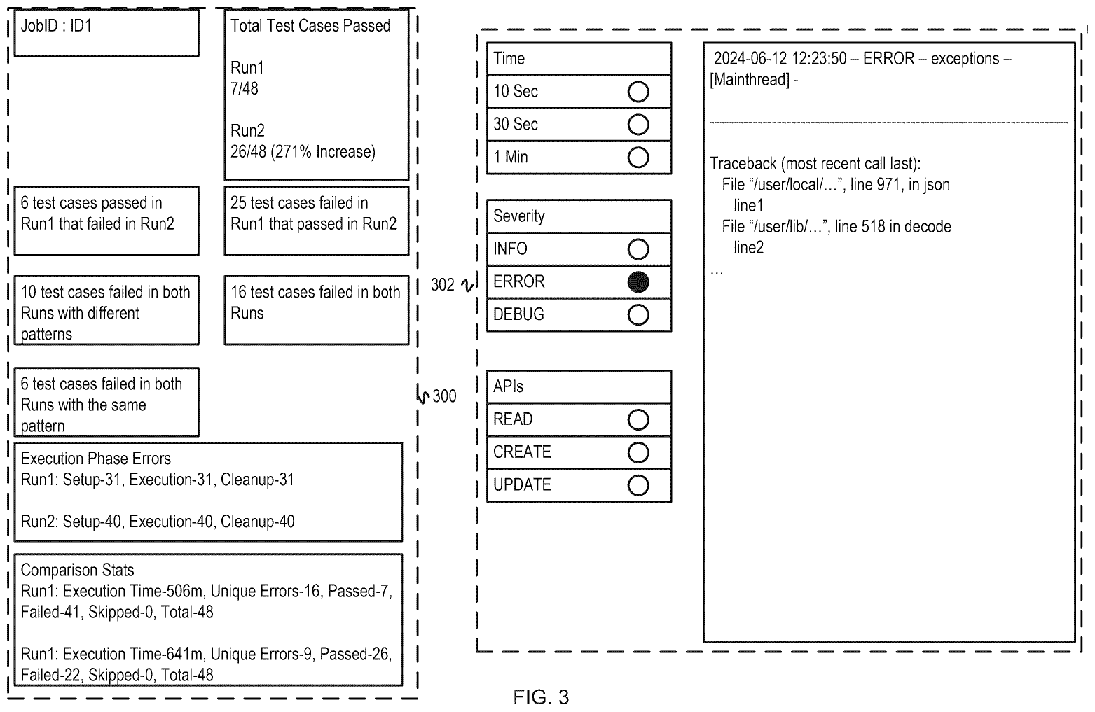

FIG. 3 is an illustrative diagram of example user interfaces (UIs) that display log data indexed by metadata and/or correlated across time periods. UI 300 displays correlated results for a job with identifier “ID1” across runs “Run1” and “Run2”. The UI 300 indicates that 7/48 test cases passed in Run1 and 26/48 test cases passed in Run2, representing a 271% increase; 6 test cases passed in Run1 that failed in Run2; 25 test cases failed in Run1 that passed in Run2; 10 test cases failed in both runs with different patterns; 16 test cases failed in both runs; and 6 test cases failed in both runs with the same pattern. The UI 300 also tracks errors in the test cases by phase. The UI 300 indicates 31 errors occurring in the setup, execution, and cleanup phases during Run1 and 40 errors occurring in the setup, execution, and cleanup phases during Run2. UI 300 displays statistics that compare Run1 with Run2. For Run1, the execution time was 506 minutes, there were 16 unique errors, 7 test cases passed, 41 test cases failed, 0 test cases skipped, and there were 48 total test cases. For Run2, the execution time was 641 minutes, there were 9 unique errors, 26 test cases passed, 2 test cases failed, 0 test cases skipped, and there were 48 total test cases.

UI 302 has clickable filters of single line logs in a display, for instance according to indices using augmented metadata of single line logs as described in the foregoing. Example filters include time, severity, and API call types. The time filter includes options of 10 seconds, 30 seconds, and 1 minute from the beginning of a job corresponding to the single line logs. The severity filter includes options of info, error, and debug. The API call types filter includes options read, create, and update. The error option for the severity filter is selected in UI 302 which displays the following single line logs:

```
2024-06-12 12:23:50 - ERROR - exceptions - [Mainthread] -
---------------------------------------------------------------------------
Traceback (most recent call last):
  File “/user/local/...”, line 971, in json
    line1
  File “/user/lib/...”, line 518 in decode
    line2
...
```

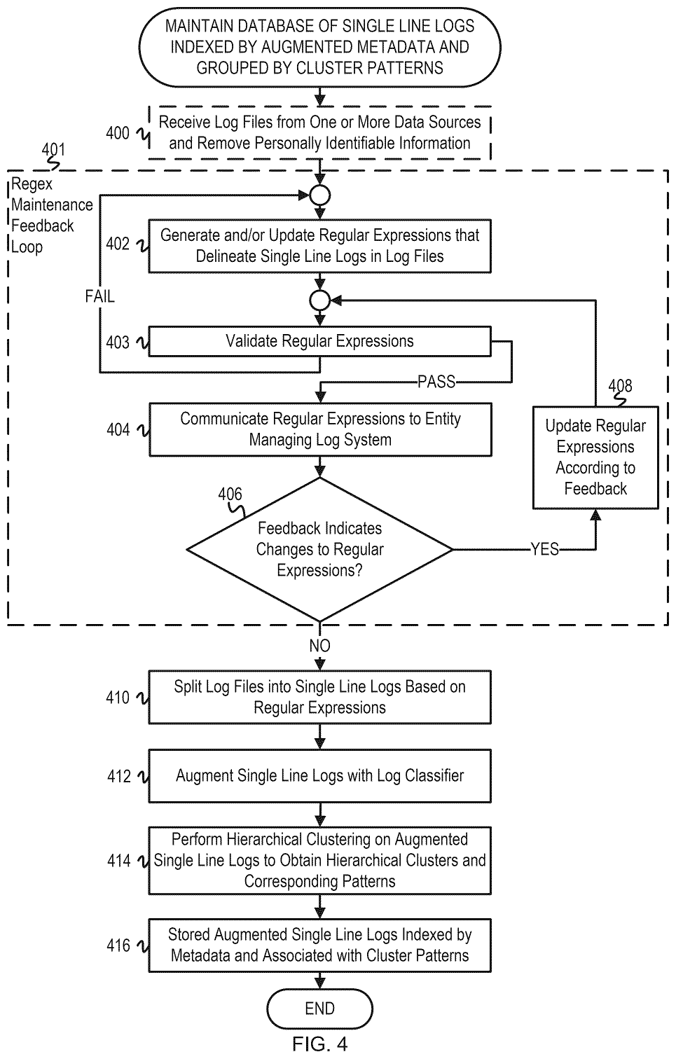

FIG. 4-7 are flowcharts of example operations for maintaining a database of single line logs augmented by metadata and clustered into hierarchical clusters corresponding to single line log patterns and using the database to respond to user queries and perform root cause analysis. The example operations are described with reference to a log augmenting/indexing system (“log system”), a hierarchical clustering model, and a log analysis/presentation module (“presentation module”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations for maintaining a database of single line logs indexed by augmented metadata and grouped by cluster patterns. At block 400, the log system receives log files that were logged by a logger at one or more data sources and removes PII from the log files. The one or more data sources can comprise testing environments for software, events occurring at endpoint devices or other computing components, etc. The log files can comprise error log files, testing log files, web server log files, security log files, etc. The log files are typically in unstructured data formats that depend on the type of logger. The log system can remove PII with third-party data loss prevention tools. Block 400 is depicted with a dashed line to indicate that the log system continuously receives log files and subsequently augments/clusters the log files, then adds the augmented/clustered log files in the subsequent operations in FIG. 4 until an external trigger occurs (e.g., an administrator disables log monitoring for the one or more data sources). Operations can occur in parallel across log files and/or can occur for batches of log files (e.g., a batch every minute, every hour, etc.).

Blocks 402, 403, 404, 406, and 408 are depicted as part of a regex maintenance feedback loop 401. The regex maintenance feedback loop 401 may only occur periodically, for instance when the database of single line logs is initially populated and subsequently at periodic intervals such as every week, month, etc. Alternatively, the regex maintenance feedback loop 401 can be triggered when an entity managing the log system is available. When the regex maintenance feedback loop 401 is not running, operational flow skips to block 410 and log files are split into single line logs based on stored regular expressions generated from previous iterations of the regex maintenance feedback loop 401.

At block 402, the log system generates and/or updates regular expressions that delineate single line logs in log files. For instance, the log system can prompt a Google Vertex AI LLM or other LLM with a prompt comprising instructions to split the log files into single line logs along with examples of regular expressions previously generated for splitting log files into single line logs. The instructions can further indicate that each single line logs corresponds to a timestamp in the log files. In embodiments where the regular expressions are updated (e.g., when the regular expressions failed validation at a previous iteration of the regex maintenance feedback loop 401), the instructions can instead indicate the current regular expressions and instruct the LLM to update quality of the regular expressions (for instance, by including locations in log files where the regular expressions failed validation).

At block 403, the regular expressions are validated. The log system validates the regular expressions against log files having known single line log delineations. If the regular expressions correctly delineate single line logs over a threshold success rate (e.g., 70%, 80%, etc.) and are thus validated, operational flow proceeds to block 404. If the regular expressions fail validation, operational flow returns to block 402.

At block 404, the log system communicates the regular expressions to an entity managing the log system. For instance, the entity can comprise a user or administrator that manages the log system. The entity then evaluates the regular expressions based on domain-level knowledge of single line logs originating from the one or more data sources to determine whether to add, remove, and/or modify regular expressions.

At block 406, the log system determines whether feedback from the entity managing the log system indicates changes to regular expressions. For instance, the feedback can indicate removal of regular expressions that are known to be incorrect by the entity, addition of regular expressions known to be correct (e.g., based on domain-level knowledge), modification of regular expressions, etc. If the feedback indicates changes to the regular expressions, operational flow proceeds to block 408. Otherwise, operational flow proceeds to block 410.

At block 408, the log system updates the regular expressions according to the feedback. For instance, the log system can add, remove, and/or modify regular expressions. Operational flow returns to block 402.

At block 410, the log system splits the log files into single line logs based on the regular expressions. The log system searches the log files for patterns indicated by the regular expressions, and each detected pattern delineates a breakpoint between single line logs (i.e., the end of one single line log and the start of another). The log system splits the log files at these breakpoints to obtain the single line logs.

At block 412, the log system augments the single line logs with a classifier. The classifier can predict metadata for each single line log such as error types (e.g., database, network, application), execution phases (e.g., setup, cleanup, execution), API call types (e.g., delete, create, post, get), etc. The log system can additionally augment each single line log with values of metadata fields such as timestamps, log severity, etc. The log classifier can comprise the Meta® Bidirectional and Auto-Regressive Transformers Large Natural Language Inference model, a machine learning classifier such as a random forest classifier, a support vector machine, a neural network classifier, etc.

At block 414, the log system performs hierarchical clustering on the augmented single line logs to obtain hierarchical clusters and corresponding patterns. Each pattern comprises a pattern satisfied by each augmented single line log in the corresponding cluster, with patterns at a lowest level of the hierarchy comprising the single line logs themselves. The hierarchical clusters and corresponding patterns are obtained using a hierarchical clustering algorithm such as the LogMine clustering algorithm. When hierarchical clusters exist from previous clustering of single line logs, the clusters are updated and augmented single line logs are assigned to clusters using the corresponding clustering algorithm. In some embodiments, the log system can only update the hierarchical clusters periodically (e.g., when a threshold number of augmented single line logs are obtained) and can, in the interim, assign augmented single line logs to clusters/patterns that most closely match each augmented single line log. Although described as using the LogMine clustering algorithm, the log system can use any clustering algorithm including non-hierarchical clustering algorithms and any form of pattern recognition to generate patterns for single line logs in each of the obtained clusters.

At block 416, the log system stores the augmented single line logs indexed by metadata and associated with corresponding cluster patterns. For instance, the metadata index can comprise indices with timestamp, API call type, single line log severity, error type, execution phase, etc. The database where the augmented single line logs are stored can have a database architecture that facilitates efficient retrieval of single line logs for each cluster/when ranges on indices are imposed (e.g., high severity single line logs for a given job and API call type occurring between two timestamps).

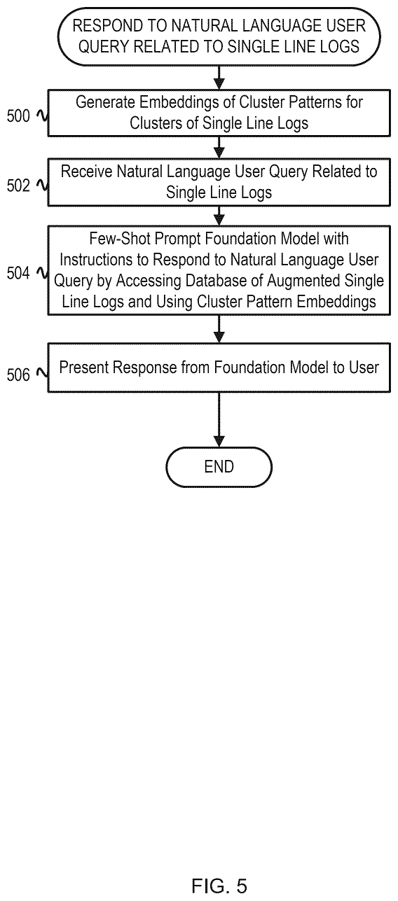

FIG. 5 is a flowchart of example operations for responding to a natural language user query related to single line logs to resolve the natural language user query. For instance, the user query can be from a user operating an endpoint device being monitored by a logger. Single line logs related to the user query have been augmented and clustered into pattern-based hierarchical clusters prior to storage in a database.

At block 500, the presentation module generates embeddings of cluster patterns for clusters of single line logs. The cluster patterns comprise patterns of hierarchical clusters of single line logs. The embeddings comprise natural language processing embeddings (e.g., word2vec embeddings) that convert text into numerical vectors. The operations at block 500 occur asynchronously to the remaining operations in FIG. 5 as single line logs are augmented and hierarchically clustered to be subsequently used for responding to user queries. Depending on input formats for a foundation model being used to respond to natural language user queries, the presentation module may omit operations for generating embeddings of cluster patterns (for instance, when the foundation model generates the embeddings at an input layer).

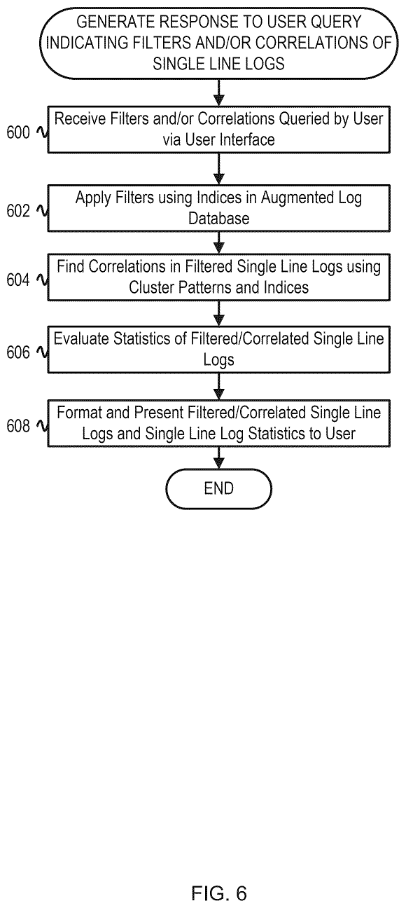

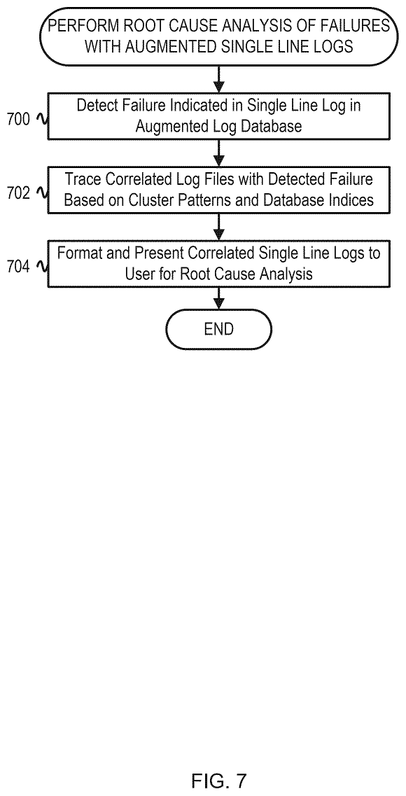

At block 502, the presentation module receives a natural language user query related to single line logs. For instance, the presentation module can receive the natural language user query via UI such as a software-as-a-service (SaaS) application UI. The UI can present a chatbot functionality to the user as well as additional analytics tools such as a dashboard that enables filtering single line logs and root cause analysis (operations for these tools are described in greater detail in reference to FIGS. 6 and 7).

At block 504, the presentation module few-shot prompts a foundation model with instructions to respond to the natural language user query by accessing a database of augmented single line logs and using the cluster pattern embeddings. The foundation model can comprise an LLM such as the GPT-4® LLM. The instructions in the few-shot prompting can indicate that each pattern embedding corresponds to a hierarchical cluster for single line logs and to use correlations between single line logs within each cluster to respond to the user queries. The instructions can also indicate indices for the database that the foundation model can search when responding to the natural language user query.

At block 506, the presentation module presents the response to the foundation model to the user. For instance, the presentation module can present the response via a UI where the user submitted the natural language query.

FIG. 6 is a flowchart of example operations for generating a response to a user query indicating filters and/or correlations of single line logs to resolve the user query. The filters can be filters for indices of single line logs such as timestamps, severity, error types, API call types, etc. The correlations can comprise correlations of single line logs across time periods, for instance to compare single line logs between 1-2 pm on a Tuesday with single line logs between 1-2 pm on a Wednesday. Alternatively, the correlations can comprise an indication by the user to obtain single line logs that are potentially correlated with filtered single line logs.

At block 600, the presentation module receives filters and/or correlations queried by a user via a UI. For instance, the UI can comprise a dashboard presented via a web browser or SaaS application UI that provides checkboxes, text fields, dropdown menus, etc. for a user to input the filters and/or correlations.

At block 602, the presentation module applies the filters using indices in a database of augmented single line logs. For instance, the presentation module can generate a query specifying the filters according to a database architecture and query syntax for the database of augmented single line logs and obtain the filtered single line logs in response to the query.

At block 604, the presentation module finds correlations in the filtered single line logs using the cluster patterns and indices. For instance, the presentation module can identify clusters associated with the filtered single line logs according to a hierarchical clustering and search within each identified cluster for single line logs that are similar to the filtered single line logs. Similarity can comprise Levenshtein distance between single line logs, number of identical fields, fuzzy matching of single line logs, etc. The presentation module can additionally identify other clusters that do not include single line logs in the filtered single line logs but that correspond to hierarchical cluster patterns that are similar to patterns of the clusters that include the filtered single line logs (e.g., according to distance between embeddings of the patterns). The presentation module can then search the other clusters as well for single line logs that are similar to the filtered single line logs.

At block 606, the presentation module evaluates statistics of the filtered and/or correlated single line logs. For instance, the presentation module can determine single line log volume (e.g., number of single line logs per hour, minute, second, etc.), and can attempt to identify outlier single line logs. Single line log outliers can be identified according to the foregoing similarity metrics used for correlating single line logs as single line logs that are distant from other single line logs according to the metrics and/or can be identified based on statistics for metadata of single line logs. For instance, a single line log can comprise an outlier if it contains values of fields (e.g., severity, timestamp, API call type) that are statistically infrequent in the filtered and/or correlated single line logs. Any statistical, density-based, and/or machine learning-based outlier detection methods can be implemented.

When the user specifies correlating single line logs across two time periods, the statistical analysis can comprise comparing statistics of single line logs between the two time periods. For instance, for testing single line logs, the presentation module can determine how many test cases passed for each time period, a percentage increase of test cases passed across time periods, test case errors by phase (setup, execution, cleanup) within each time period, which test cases failed in both time periods, which test cases passed in only one of the time periods, etc.

At block 608, the presentation module formats and presents filtered and/or correlated single line logs and single line log statistics to the user. The presentation module extracts relevant data to the user query to present to the user. For instance, the presentation module can highlight identified outlier single line logs and/or other anomalous statistics. The presentation module can present the filtered and/or correlated single line logs through a user interface that allows the user to click and inspect individual single line logs and sort single line logs by metadata parameters.

FIG. 7 is a flowchart of example operations for performing root cause analysis of failures with augmented single line logs. At block 700, the presentation module detects a failure indicated in a single line log in an augmented log database. For instance, the presentation module can detect that a single line log comprises an error field or other keyword that indicates a failure. After a single line log is detected and/or correlated to a failure, the presentation module can activate a flag in the augmented log database for these single line logs so that they are not analyzed multiple times for root cause analysis.

At block 702, the presentation module traces correlated single line log files to the detected failure based on cluster patterns and database indices. The presentation module searches for single line logs that are similar to the single line log indicating the detected failure, for instance as described in the description of block 604 in reference to FIG. 6. This search can be refined based on the type of failure. For instance, when the detected failure indicated in the single line log is a stack traceback, the presentation module can search for all single line logs with the same timestamp and error type that indicate a stack traceback to obtain the full stack traceback for the failure.

At block 704, the presentation module formats and presents the correlated single line logs to the user for root cause analysis. The correlated single line logs can be presented via a UI that has functionality for filtering and inspecting as described in block 608 in reference to FIG. 6.

### Variations

Operations for parsing log files into single line logs, augmenting single line logs with classifications and other metadata parameters, and storage of the single line logs in a database indexed by the classifications/metadata parameters can alternatively be referred to as adding structure to the log files to obtain structured logs.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 4 can be performed in parallel or concurrently across log files. The regex maintenance feedback loop 401 in FIG. 4 can be omitted for some log files. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

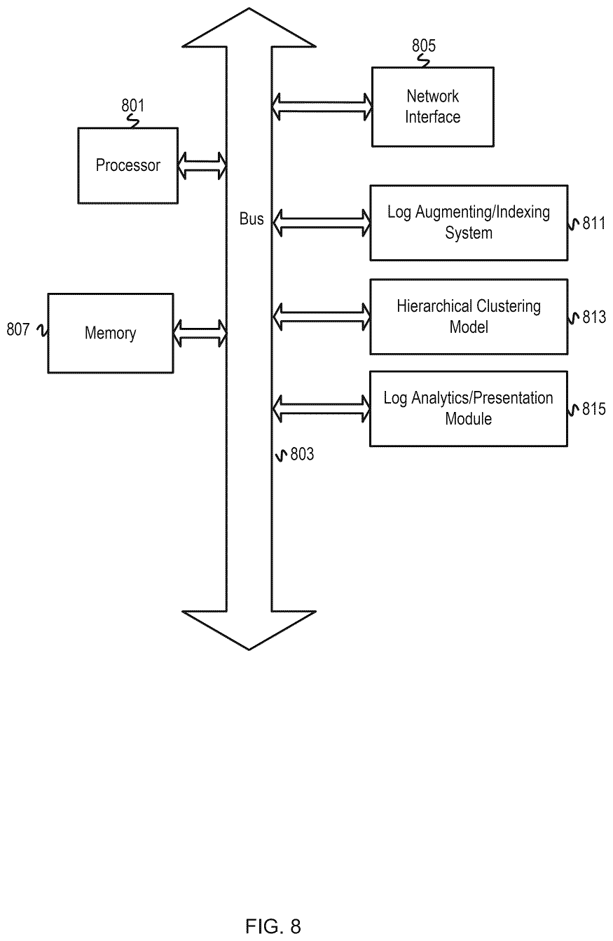

FIG. 8 depicts an example computer system with a log augmenting/indexing system, a hierarchical clustering model, and a log analytics/presentation module. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes a log augmenting/indexing system (“log system”) 811, a hierarchical clustering model 813, and a log analytics/presentation module (“presentation module”) 815. The log system 811 prompts an LLM to generate regular expressions to split log files into single line logs, updating the regular expressions in a feedback loop with an entity managing the log system 811. The log system 811 uses the regular expressions to split the log files into single line logs and then augments the single line logs with log classifications and other metadata. The hierarchical clustering model 813 clusters the augmented single line logs into hierarchical clusters that are each associated with patterns for the single line logs therein. The log system 811 stores the augmented single line logs in a database indexed by metadata/classifications and associated with corresponding clusters/patterns. The presentation module 815 accesses the database to respond to user queries and facilitate root cause analysis and correlation analysis. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

1. A method comprising:
processing one or more log files according to regular expressions to obtain augmented single line logs, wherein processing the one or more log files comprises,
identifying the regular expressions as corresponding to first patterns that delineate single line logs in each of the one or more log files;
splitting the one or more log files according to the identified regular expressions to obtain single line logs; and
augmenting the single line logs with at least one of classifications and values of metadata fields to obtain the augmented single line logs;
clustering the augmented single line logs to obtain a plurality of clusters; and
resolving a request for data in the one or more log files based, at least in part, on the plurality of clusters, the identified regular expressions, and the at least one of classifications and values of metadata fields in the augmented single line logs.

2. The method of claim 1, wherein identifying the regular expressions comprises prompting a first foundation model with a first prompt comprising a task instruction to identify the regular expressions based on delineating single line logs in the one or more log files, wherein the prompt indicates that one or more log files are delineated by timestamps.

3. The method of claim 2, wherein the prompt further indicates regular expressions previously used to parse one or more log files.

4. The method of claim 2, wherein identifying the regular expressions further comprises:
presenting the identified regular expressions to an entity managing the one or more log files; and
updating the identified regular expressions based on feedback from the entity.

5. The method of claim 1, wherein clustering the augmented single line logs comprises hierarchical clustering the augmented single line logs according to second patterns corresponding to hierarchical groupings of the augmented single line logs to obtain the plurality of clusters.

6. The method of claim 5, wherein resolving the request comprises:
generating a second prompt comprising a task instruction to a second foundation model to respond to the request based, at least in part, on the augmented single line logs, the plurality of clusters, and the second patterns; and
prompting the second foundation model with the second prompt to obtain a response to the request.

7. The method of claim 6, wherein the second prompt further comprises an instruction to summarize augmented single line logs indicated in the response.

8. The method of claim 5, where hierarchical clustering the augmented single line logs comprises clustering the augmented single line logs according to the LogMine algorithm.

9. The method of claim 1, further comprising storing the augmented single line logs indexed by at least one of the classifications, the values of metadata fields, the identified regular expressions, and the plurality of clusters.

10. The method of claim 1, wherein resolving the request comprises:
generating a request to a database storing the augmented single line logs;
extracting relevant data to the request from augmented single line logs returned by the database; and
generating a response to the request based on the relevant data.

11. The method of claim 10, wherein the relevant data comprises clusters for the augmented single line logs and correlations between the augmented single line logs.

12. The method of claim 11, wherein the correlations between the augmented single line logs comprise correlations for one or more log files across multiple distinct time periods.

13. A non-transitory machine-readable medium having program code stored thereon, the program code comprising instructions to:
prompt a first foundation model with a first prompt comprising a task instruction to identify regular expressions corresponding to first patterns that delineate single line logs in one or more log files;
split the one or more log files according to the identified regular expressions to obtain single line logs;
augment the single line logs with at least one of classifications and values of metadata fields to obtain augmented single line logs;
cluster the augmented single line logs to obtain a plurality of clusters; and
respond to a query for data in the one or more log files based, at least in part, on the plurality of clusters, the identified regular expressions, and the classifications.

14. The non-transitory machine-readable medium of claim 13, wherein the first prompt indicates that log files are delineated by timestamps.

15. The non-transitory machine-readable medium of claim 13, wherein the instructions to cluster the augmented single line logs comprise instructions to perform hierarchical clustering on the augmented single line logs according to second patterns corresponding to hierarchical groupings of the augmented single line logs.

16. The non-transitory machine-readable medium of claim 15, wherein the program code to respond to the query comprises instructions to:
generate a second prompt comprising a task instruction to a second foundation model to respond to the query based, at least in part, on the augmented single line logs, the plurality of clusters, and the second patterns; and
prompt the second foundation model with the second prompt to obtain a response to the query.

17. An apparatus comprising:
a processor; and
a machine-readable medium having instructions stored thereon that are executable by the processor to cause the apparatus to,
maintain a database of augmented single line logs indexed by at least one of classifications and values of metadata fields, wherein the instructions to maintain the database comprise executable by the processor to cause the apparatus to, as log files are received,
prompt a first foundation model with a first prompt comprising a task instruction to identify regular expressions corresponding to first patterns that delineate single line logs in the log files;
parse the log files according to the identified regular expressions to obtain single line logs;
augment the single line logs with at least one of classifications and values of metadata fields to obtain augmented single line logs;
cluster the augmented single line logs to obtain a plurality of clusters; and
store the augmented single line logs in the database indexed by the at least one of classifications and values of metadata fields and associated with corresponding clusters in the plurality of clusters.

18. The apparatus of claim 17, wherein the first prompt indicates that log files are delineated by timestamps.

19. The apparatus of claim 17, wherein the instructions to cluster the augmented single line logs comprise instructions executable by the processor to cause the apparatus to perform hierarchical clustering on the augmented single line logs according to second patterns corresponding to hierarchical groupings of the augmented single line logs.

20. The apparatus of claim 19, further comprising instructions executable by the processor to cause the apparatus to respond to a respond to a query for data in the log files, wherein the instructions to respond to the query comprise instructions executable by the processor to cause the apparatus to,
generate a second prompt comprising a task instruction to a second foundation model to respond to the query based, at least in part, on the augmented single line logs, the plurality of clusters, and the second patterns; and
prompt the second foundation model with the second prompt to obtain a response to the query.
